(19) United States
(12) Patent Application Publication
(10) Pub. No.: US 2021/0080182 A1
(43) Pub. Date: Mar. 18, 2021

(54) FURNACE ROLLER ASSEMBLY

(71) Applicant: Armstrong Kover Kwick, Inc., Pittsburgh, PA (US)

(72) Inventor: Dave Shearer, Pittsburgh, PA (US)

(21) Appl. No.: 16/568,581

(22) Filed: Sep. 12, 2019

(51) Int. Cl. F27D 3/02; F27B 9/24; F27D 1/12; F27D 99/00

(52) U.S. Cl. CPC F27D 3/026; F27B 9/2407; F27B 2009/3066; F27D 99/00; F27D 1/12

(57) ABSTRACT

A furnace roller assembly having a fluid-cooled shaft that is covered by an interface performance material comprising both ceramic millboard and a wire brush bristled-material is disclosed. The roller assembly can be used as part of a conveyance system in a finishing mill to support and transport steel sheet through an annealing furnace. The fluid-cooled shaft and the ceramic millboard plus wire brush interface performance material arrangement provide the means to provide effective insulation for the shaft while preventing degradation of the covering on the shaft.

### FIELD OF THE INVENTION

Embodiments relate to a furnace roller assembly having a fluid-cooled shaft that is covered by an interface performance material comprising both ceramic millboard and a wire brush bristled-material.

### BACKGROUND OF THE INVENTION

Rollers are typically used in steel processing, and in particular in steel finishing mills, to support a sheet, slab, billet, etc. of steel as it travels through a conditioning furnace. For instance, rollers can be used as part of a conveyance system to support a sheet of steel being annealed in an annealing furnace. Due to the temperatures within the conditioning furnaces (e.g., 2,200° F.) and the disparate material properties between the roller shafts and the steel sheet, an undesired effect of the rollers marking up the surface of the steel sheet tends to occur. Conventional methods for addressing this problem are limited to covering the roller shaft with a millboard material or a wire brush. Conventional covering materials tend to degrade easily or fail to provide effective insulation (insulation from heat) for the shaft, thereby allowing the shaft to warp and/or collapse. Conventional furnace roller systems and methods can be appreciated from U.S. Pat. Nos. 3,087,599, 5,362,230, US 2007/0180884, US 2010/0239991, WO 2001/088452, EP 0298019, and EP 0635691.

The present invention is directed toward overcoming one or more of the above-identified problems.

### BRIEF SUMMARY OF THE INVENTION

Embodiments relate to a furnace roller assembly having a fluid-cooled shaft that is covered by an interface performance material comprising both ceramic millboard and a wire brush bristled-material. The roller assembly can be used as part of a conveyance system in a finishing mill to support and transport steel sheet through an annealing furnace. The fluid-cooled shaft and the ceramic millboard plus wire brush interface performance material arrangement provide the means to provide effective insulation for the shaft while preventing degradation of the covering on the shaft. This can prolong the service life of the roller assembly.

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages and possible applications of the present invention will be more apparent from the following more particular description thereof, presented in conjunction with the following drawings, in which:

FIG. 1 shows an embodiment of the roller assembly being used to transport steel sheet in a conditioning furnace.

FIG. 2 shows an embodiment of a roller assembly.

FIG. 3 shows a cross-sectional view of an embodiment of a roller assembly.

FIG. 4 shows another cross-sectional view of an embodiment of a roller assembly showing an embodiment of the fluid-cooling system.

FIG. 5 shows another cross-sectional view of an embodiment of a roller assembly showing an embodiment of the fluid-cooling system.

FIG. 6 shows a flow rate versus pressure drop and outlet temperature plot for a simulated test conducted on an embodiment of the roller assembly.

FIG. 7 is a temperature v. thermal conductivity plot for a simulated test conducted on an embodiment of the roller assembly.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

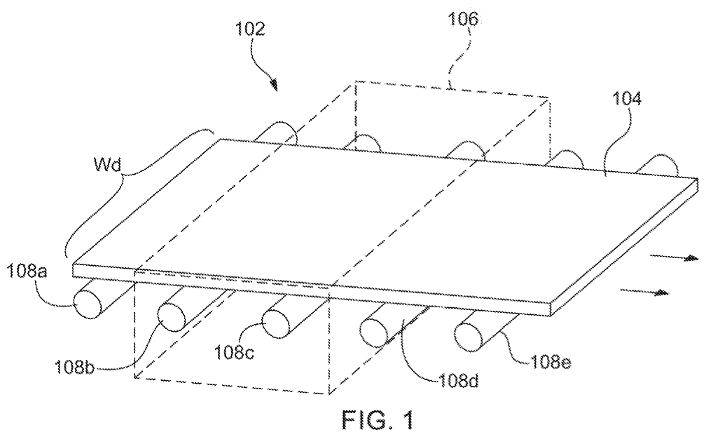

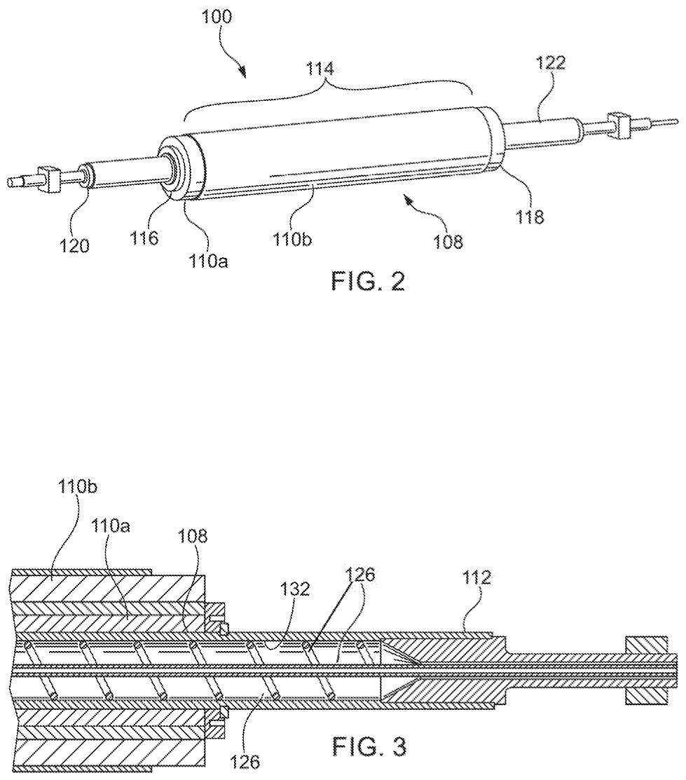

Referring to FIGS. 1-3, embodiments relate to a roller assembly 100 configured to be part of a conveyance system 102. For instance, the conveyance system 102 can include a plurality of roller assemblies 100 arranged in a serial manner to support and transport product 104. The roller assembly 100 can be used as part of a conveyance system 102 in a steel finishing mill (e.g., an annealing line, a pickling line, a galvanizing line, etc.). It is contemplated for the roller assembly 100 to be used as part of a conveyance system 102 in a finishing mill to support and transport steel sheet 104 through an annealing furnace 106, and thus specific examples disclosed herein are related to such an application, but it should be understood that the roller assembly 100 can be used in other types of finishing mills.

The roller assembly 100 can have a shaft 108. The shaft 108 can be made from steel, steel alloy, or other metal that can withstand the loads and temperatures for any of the applications described herein. The shaft 108 can be sheathed, shrouded, covered, masked, encased, etc. by at least one interface performance material 110. The interface performance material 110 can be designed to both protect the shaft 108 and to prevent the shaft 108 from damaging the product 104 (e.g., steel sheet) the roller assembly 100 is designed to support and transport. The shaft 108 can have an interface performance material 110 that is millboard (e.g., ceramic), an interface performance material 110 that is a bristled material (e.g., wire-brush), etc. In one embodiment, the shaft 108 has a first interface performance material 110a and a second interface performance material 110b. The first interface performance material 110a can be ceramic millboard applied to an outer surface 112 of the shaft 108. The second interface performance material 110b can be wire-brush bristled-material applied to an outer surface 112 of the first interface performance material 110a.

The shaft 108 can an elongated cylindrical object having a shaft length 114, a shaft outer surface 112, a shaft first end 116, and a shaft second end 118. The shaft first end 116 can include a first hub and bearing assembly 120, and the shaft second end 118 can include a second hub and bearing assembly 122. This can be done to facilitate mechanical connection of The shaft 108 to a rotary unit and allow the shaft 108 to be rotated freely. A distance of the shaft 108 between the first and second hub and bearing assemblies 120, 122 is the shaft length 114. the shaft length 114 can define the surface area of the shaft outer surface 112 that would come into contact with the steel sheet 104 in the absence of the interface performance material 110. Thus, the interface performance material 110 can be applied to the shaft 108 so that it covers the shaft length 114. For instance, the steel sheet 104 can have a width Wd and the shaft length 114 can be ≥Wd so that when the steel sheet 104 is supported and transported by the roller assembly 100, the steel sheet 104 makes contact with the interface performance material 110 applied to the shaft 108. As noted herein, the first interface performance material 110a can be applied to an outer surface 112 of the shaft 108, and the second interface performance material 110b can applied to an outer surface 112 of the first interface performance material 110a. Thus, the roller assembly 100 can be configured so that the steel sheet 104 comes into direct contact with the second interface performance material 110b.

The conveyance system 102 can include a plurality of roller assemblies 100 or shafts 108 (e.g., a first shaft 108a, a second shaft 108b, a third shaft 108c, a fourth shaft 108d, fifth shaft 108e, etc.). The plurality of shafts 108 can be arranged in a serial manner to generate part of the conveyance system 102. For instance, the first shaft 108a can be placed adjacent the second shaft 108b, which can be placed adjacent the third shaft 108c, which can be placed adjacent the fourth shaft 108d, which can be placed adjacent the fifth shaft 108e, etc. to generate a conveyor upon which the steel sheet 104 will rest. Each of the first and second hub and bearing assemblies 120, 122 of each of the shafts 108 can be in connection with a rotary unit (e.g., an electrical motor, pneumatic motor, hydraulic motor, etc.). Each shaft 108 can have a separate, dedicated rotary unit, or any one or combination of shafts 108 can share a rotary unit. Upon actuation of the rotary unit(s), the shafts 108 rotate, thereby causing the steel sheet 104 to move. At least a portion of the roller assembly 100 can extend into or through a conditioning furnace 106 (e.g., an annealing furnace). It is contemplated for the furnace to expose the steel sheet 104 to an elevated temperature for annealing. Thus, the temperatures within the furnace 106 can be within a range from ambient temperature to annealing temperatures. The annealing temperature will depend on the type of steel and steel alloy used to fabricate the steel sheet 104. As a non-limiting example, the annealing temperature for stainless steel sheet 104 would be approximately 2,200° F.

The first interface performance material 110a can be ceramic millboard applied to an outer surface 112 of the shaft 108. The first interface performance material 110a is designed to protect the shaft 108 by insulating the shaft 108 from the heat. The second interface performance material 110b can be wire-brush bristled-material (or wire-brush) applied to an outer surface 112 of the first interface performance material 110a. The second interface performance material 110b is designed to protect the surface of the steel sheet 104 from markings (e.g., scratches, engravings, dents, etc.) that otherwise would occur when the steel sheet 104 is traversed over the roller assembly 100.

In an exemplary embodiment, the ceramic millboard material can be die cut into discs, which can range from 1 mm to 10 mm thick (and may preferably be 4.5 mm thick). The discs can be stacked vertically in a press (e.g., a 250 ton press) and compressed onto the shaft 108. This can involve compressing the discs to a hardness of 60-62 Shore D. The ceramic millboard can then be held in place with retaining rings on each end. In some embodiments, heat dispersion discs can be placed between at least two ceramic millboard discs (e.g., a stainless steel heat dispersion disc can be placed between every 3 discs of ceramic millboard) to aid in heat dispersion. The heat dispersion discs can range in thickness from 0.01 mm to 2 mm (and may preferably be 0.08 mm thick). In some embodiments, the heat dispersion discs can be embedded into the ceramic millboard discs during compression in the press. The ceramic millboard (and the heat dispersion discs, if any are used) can be cut to a smooth and concentric finish in a lathe, for example, before spiral wrapping the ceramic millboard material with a Inconel 600 wire brush (e.g., a 0.020-inch diameter filaments). The filaments can be placed into a backing channel and crimped together. The channel can be made from Inconel 600. The channel can then be welded to a retaining plate, and then spiral wrapped around the ceramic millboard material in a helical close-wound fashion. The bristles can be trimmed in a lathe, for example, for a concentric finish.

While it is contemplated for each shaft 108 in the conveyance system 104 to have the same or similar construction, it should be noted that any one or combination of shafts 108 in the conveyance system 104 can have the same or different construction. For instance, the first shaft 108 can have a first and second interface performance material 110 that matches the first and second interface performance material 110 of the second shaft 108. As another example, first shaft 108 can have a first and a second interface performance material 110, whereas the second shaft 108 can have only a first or a second interface performance material 110. As another example, each of the first shaft 108 and second shaft can have a first and a second interface performance material 100, but their respective first and a second interface performance materials 110 can differ in type, thickness, etc.

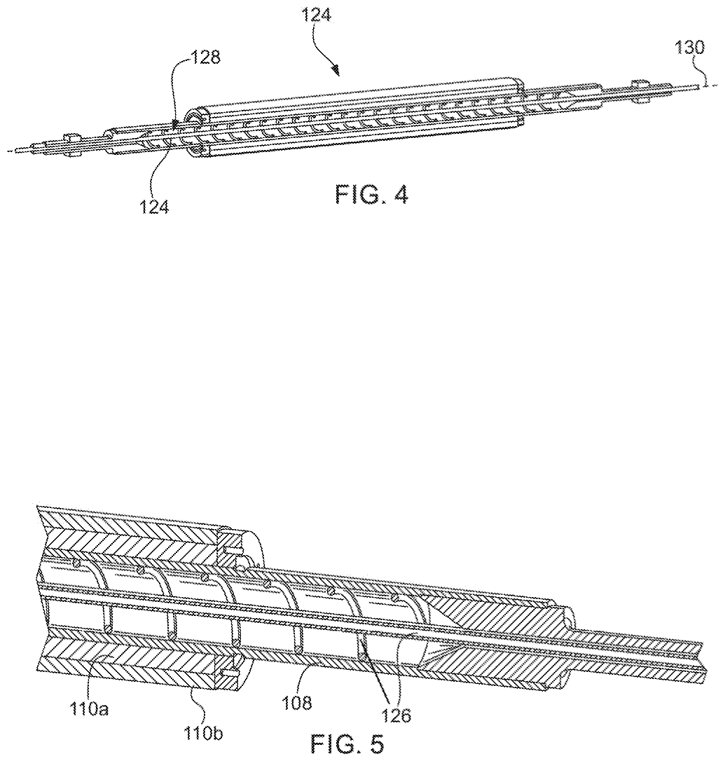

Referring to FIGS. 4-5, any one or combination of the shafts 108 in the roller assembly 100 can be configured to include a fluid-cooling system 124 configured to circulate coolant. It is contemplated the coolant to be liquid, but it can be gas or a mixture of liquid and gas. The fluid-cooling system can be designed to circulate coolant that is water, oil, alcohol, acid solution, etc. The fluid-cooling system 124 can include a conduit 126 running through an interior of the shaft 108. For instance, the shaft 108 can be an elongated cylindrical object having a hollow interior 128. The conduit 126 can be configured to run along the longitudinal length of the shaft 108 and be further configured to facilitate flow of the coolant so as to allow for heat transfer from the shaft 108 (and/or hub and bearing assembly 120, 122) to the coolant and away from the shaft 108 (and/or hub and bearing assembly 120, 122). In some embodiments, the conduit 126 is a channel that runs parallel with the longitudinal axis 130. This can include running along a central portion of the shaft interior 128 or any other position in the shaft interior 128. In some embodiments, the conduit 126 is a channel that runs in a spiral manner about the inner surface 132 of the shaft 108 interior and extends along the longitudinal axis 130. Other patterns can include zig-zag, serpentine, chevron, etc. In some embodiments, the conduit 126 is a channel that runs parallel with the longitudinal axis 130 and runs in a spiral manner about the inner surface 132 of the shaft interior 128 while extending along the longitudinal axis 130. Other configurations can be used. The configuration of the conduit 126 can be selected to optimize operational efficiency and maximize heat transfer. The conduit 126 can run the entire length 114 of the shaft 108, only partially through the shaft 108, extend beyond the length 114 of the shaft 108, etc.

In an exemplary embodiment, the spiral portion of the conduit 126 can be a hollow or solid round bar that is made of 304 stainless steel, having a diameter ranging from 0.1 inches to 1 inch (and may preferably be 0.5 inches). The pitch of the spiral can be within a range from 1 inch in pitch to 8 inches in pitch (and may preferably be 4 inches in pitch). The channel that runs parallel with the longitudinal axis 130 can be a hollow Sch 40 pipe that is made of 304 stainless steel, having a diameter ranging from 0.1 inches to 1 inch (and may preferably be 0.5 inches). This portion may be used to deliver coolant to the end of the shaft 108 so that the coolant can be returned in a spiral fashion following the spiral portion of the conduit 126. In some embodiments, the coolant can be made to enter and exit the same end of the shaft 108 using a dual port rotary union.

In one embodiment, the conduit 126 extends from the shaft first end 116 (or first hub and bearing assembly 120) to run in a spiral manner along the longitudinal axis 130 to the shaft second end 118 (or second hub and bearing assembly 122), runs through or against a heat exchanger, and then extends back through the shaft first end 116 (or first hub and bearing assembly 120) to connect with the spirally configured portion of the conduit 126. The coolant can be caused to flow through the conduit 126 passively (e.g., via differential pressure gradients caused by the transfer of heat into and out from the coolant) or actively (e.g., a pump). As the coolant passes through the conduit 126, heat is transferred from the shaft 108 to the coolant, wherein the heat absorbed by the coolant is transferred out of the fluid-cooling system 124 at the heat exchanger. The fluid-cooling system 124 can be an open loop system or a closed loop system.

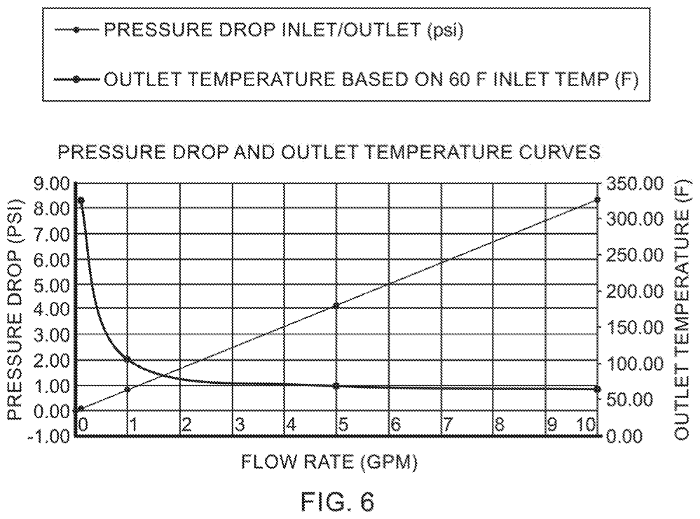

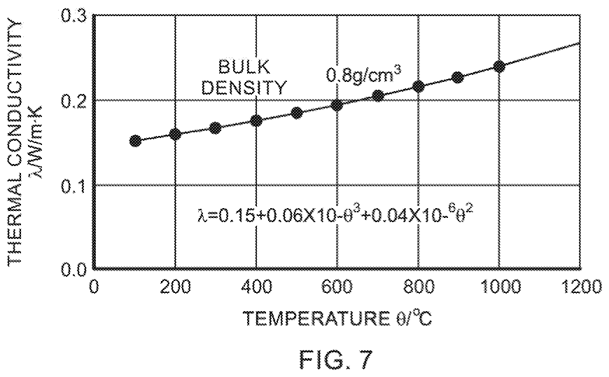

Referring to FIGS. 6-7, performance tests have been conducted via simulations for embodiments of the roller assembly 100. These tests included fluid flow analyses including heat transfer of the roller assembly 100 based on various flow rates of water based-coolant and structural stress analyses to examine the stresses within the shaft 108 components and the associated thermal expansion. For the simulation, a roller assembly 100 was modeled to have a shaft 108 with a ceramic millboard 110a disposed on the shaft 108 and a wire brush 110b disposed on the millboard 110a.

A fluid flow analysis utilizing Computational Fluid Dynamics (CFD) was performed to determine the coolant flowrate based upon fixed input pressures and the heat transfer throughout the roller assembly 100 based on contact between the brush material 110b and the stainless steel sheet 104. Water was used as the coolant with an inlet temperature of 60° F. Inlet flow rate was simulated at 0.1 gpm, 1 gpm, 5 gpm, and 10 gpm. Outlet conditions were specified in the simulation as 0 psi. A flow rate versus pressure drop and outlet temperature curve was generated (see FIG. 6). The sheet steel 104 in contact with the roller assembly 100 was specified in the simulation to be stainless steel at a constant temperature of 1900° F. on the outer surface to account for thermal conductivity. The air surrounding the roller assembly 100 was specified in the simulation to be at a constant temperature of 2250° F. on the far field boundaries of a space defined as the surrounding air volume to account for thermal conductivity.

A structural analysis of the roller assembly 100 was performed to examine the stresses under load and the thermal expansion based on the heat distribution stemming from the fluid flow/heat transfer analyses. Temperature distributions from the fluid flow/heat transfer analyses were mapped onto the geometry and thermal expansion (and any resulting stresses) was simulated based upon a reference temperature of 70° F. Structural loading was defined as a three part loading: thermal, gravitational, and force loading from sheet steel tension. The sheet steel 104 tension was unknown at the time of the analyses, therefore downward forces on the shaft 108 were modeled to vary from 0 lbf to 500 lbf in 100 lbf increments.

In each analysis conducted, coolant volume was modeled in the simulation to be liquid water, air volume was modeled to be air, all components of the roller assembly 100 were modeled to be 304 Stainless Steel, the stainless steel strip 104 was modeled to be 304 Stainless Steel, the millboard cover 110a was modeled as millboard material having: thermal conductivity as shown in FIG. 7; a thermal conductivity at 1000° C.; a specific heat value of 0.2 BTU/(lbm-F); a density of 40 lb/ft³; and a modulus of rupture of Kaowool 830 millboard, and the wire brush 110b was modeled to be a solid model with a reduced thermal conductivity.

At a simulated flow of 0.1 gpm, the temperature ranges experienced by the roller assembly 100 were between 60° F. and 2250° F. The peak temperature of the shaft 108 was 497° F. The peak temperature of the millboard 110a (at the outer surface of the millboard 110a) was 1815° F. The peak temperature of the hub and bearing assemblies 120, 122 was 343° F. The peak heat flux at the boundary of the internal coolant volume and the inner diameter of the shaft 108 was 16,700 W/m². The peak fluid velocity was 1.3 in/sec (or 0.11 ft/sec). The peak thermal expansion of the roller assembly 100 was 0.368 inches. The peak radial expansion of the roller assembly 100 was 0.023 inches. The peak thermal expansion of the straight section of conduit 126 was 0.366 inches. The peak thermal expansion of the spiral section of the conduit 126 was 0.299 inches. The peak deflection under load (thermal, gravitational, and external roll load) was 0.373 inches.

At a simulated flow of 1.0 gpm, the temperature ranges experienced by the roller assembly 100 were between 60° F. and 2250° F. The peak temperature of the shaft 108 was 253° F. The peak temperature of the millboard 110a (at the outer surface of the millboard 110a) was 1802° F. The peak temperature of the hub and bearing assemblies 120, 122 was 113° F. The peak heat flux at the boundary of the internal coolant volume and the inner diameter of the shaft 108 was 9,391 W/m². The peak fluid velocity was 14.72 in/sec (or 1.22 ft/sec). The peak thermal expansion of the roller assembly 100 was 0.129 inches. The peak radial expansion of the roller assembly 100 was 0.006 inches. The peak thermal expansion of the straight section of conduit 126 was 0.128 inches. The peak thermal expansion of the spiral section of the conduit 126 was 0.116 inches. The peak deflection under load (thermal, gravitational, and external roll load) was 0.164 inches.

At a simulated flow of 5.0 gpm, the temperature ranges experienced by the roller assembly 100 were between 60° F. and 2250° F. The peak temperature of the shaft 108 was 144° F. The peak temperature of the millboard 110a (at the outer surface of the millboard 110a) was 1769° F. The peak temperature of the hub and bearing assemblies 120, 122 was 74.5° F. The peak heat flux at the boundary of the internal coolant volume and the inner diameter of the shaft 108 was 10,420 W/m². The peak fluid velocity was 75.32 in/sec (or 6.27 ft/sec). The peak thermal expansion of the roller assembly 100 was 0.049 inches. The peak radial expansion of the roller assembly 100 was 0.002 inches. The peak thermal expansion of the straight section of conduit 126 was 0.041 inches. The peak thermal expansion of the spiral section of the conduit 126 was 0.049 inches. The peak deflection under load (thermal, gravitational, and external roll load) was 0.152 inches.

At a simulated flow of 10.0 gpm, the temperature ranges experienced by the roller assembly 100 were between 60° F. and 2250° F. The peak temperature of the shaft 108 was 114.5° F. The peak temperature of the millboard 110a (at the outer surface of the millboard 110a) was 1794° F. The peak temperature of the hub and bearing assemblies 120, 122 was 67.6° F. The peak heat flux at the boundary of the internal coolant volume and the inner diameter of the shaft 108 was 10,950 W/m². The peak fluid velocity was 150.4 in/sec (or 12.53 ft/sec). The peak thermal expansion of the roller assembly 100 was 0.031 inches. The peak radial expansion of the roller assembly 100 was 0.002 inches. The peak thermal expansion of the straight section of conduit 126 was 0.018 inches. The peak thermal expansion of the spiral section of the conduit 126 was 0.031 inches. The peak deflection under load (thermal, gravitational, and external roll load) was 0.146 inches.

With respect to the flow rate versus pressure drop and within the flow rate range of 0.1 gpm to 10 gpm, the pressure drop had a linear proportional response. With respect to the flow rate versus temperature, results indicate high sensitivity within the range of 0.1 to 1 gpm. Above 1 gpm, the temperature at the outlet was fairly stable within a confined range. Peak temperatures were observed when the coolant flow rate was 0.1 gpm. Peak shaft temperatures were on the order of 497° F. located at the center of the shaft towards the distal ends. However, these results were at a very low flow rate of 0.1 gpm. For instance, peak temperatures at 1 gpm, were in the magnitude of 253° F. Peak bearing surface temperatures were found to be 343° F. when the flow rate thought the shaft was 0.1 gpm. Peak temperature occurred on the bearing surface associated with the inlet/outlet end-piece. Once again this peak value was at a very low flow rate. For instance, peak temperatures at 1 gpm were in the magnitude of 113° F.

Peak coolant velocity occurred when the coolant flow rate was 10 gpm. Peak velocities were on the order of 12.53 ft/sec. In the simulation, the bearings were setup in two configurations: 1) the drive end was fixed and the other end was allowed to float; 2) both ends were fixed. A significant reduction in stresses occurred on the end pieces for the fixed-floating setup when compared to the fixed-fixed setup. In any event, the stresses in the shaft area were below the yield strength of the material comprising the shaft.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the endpoints.

What is claimed is:

1. A roller assembly, comprising:
a shaft comprising a first interface performance material applied of an outer surface of the shaft and a second interface performance material applied to an outer surface of the first interface performance material; and
a fluid-cooling system configured to transport coolant within an interior of the shaft;
wherein the roller assembly is configured to be part of a conveyance system to transport product.

2. The roller assembly of claim 1, wherein the conveyance system comprises a plurality of roller assemblies.

3. The roller assembly of claim 1, wherein the conveyance system is configured to support and transport steel sheet into and out-from an annealing furnace.

4. The roller assembly of claim 1, wherein:
the shaft comprises a hollow interior; and
the fluid-cooling system is positioning at least partially within the hollow interior.

5. The roller assembly of claim 1, wherein the first interface performance material is configured to thermally insulate the shaft.

6. The roller assembly of claim 1, wherein the first interface performance material comprises ceramic.

7. The roller assembly of claim 1, wherein the second interface performance material is configured to prevent the shaft from marking the product.

8. The roller assembly of claim 1, wherein the second interface performance material comprises wire brush material.

9. The roller assembly of claim 1, wherein the fluid-cooling system is configured to circulate water as the coolant.

10. The roller assembly of claim 4, wherein:
the shaft comprises an elongated object having a shaft first and a shaft second end, forming a longitudinal axis running from the shaft first to the shaft second end;
the fluid-cooling system comprises conduit that runs parallel with the longitudinal axis and/or conduit that runs in a spiral manner and extends along the longitudinal axis.

11. The roller assembly of claim 10, wherein the conduit that runs parallel with the longitudinal axis is located at a central portion of the hollow interior.

12. The roller assembly of claim 10, wherein the conduit that runs in a spiral manner is located at an inner surface of the hollow interior.

13. The roller assembly of claim 1, wherein the fluid-cooling system comprises a heat exchanger.

14. The roller assembly of claim 10, wherein:
the fluid-cooling system comprises a heat exchanger; and
the conduit extends from the shaft first end to run in a spiral manner along the longitudinal axis to the shaft second end, runs through or against the heat exchanger, and extends back through the shaft first end to connect with the spirally configured portion of the conduit.

15. The roller assembly of claim 1, wherein the fluid-cooling system is configured to allow the coolant to flow passively and/or cause the fluid to flow actively via a pump.

16. A conveyance system, comprising:
a plurality of roller assemblies arranged in a serial manner, each roller assembly comprising:
a shaft comprising a first interface performance material applied of an outer surface of the shaft and a second interface performance material applied to an outer surface of the first interface performance material; and
a fluid-cooling system configured to transport coolant within an interior of the shaft.

17. The conveyance system of claim 16, wherein:
the plurality of roller assemblies comprises a first roller assembly having a first shaft and a second roller assembly having a second shaft;
the second shaft has a first interface performance material that is the same as the first interface performance material for the first shaft; and

18. The conveyance system of claim 16, wherein:
the plurality of roller assemblies comprises a first roller assembly having a first shaft and a second roller assembly having a second shaft; and
the second shaft has a second interface performance material that is the same as the second interface performance material for the first shaft.

19. The conveyance system of claim 16, wherein:
the plurality of roller assemblies comprises a first roller assembly having a first shaft and a second roller assembly having a second shaft; and
the second shaft has a first interface performance material that is different from the first interface performance material for the first shaft.

20. The conveyance system of claim 16, wherein:
the plurality of roller assemblies comprises a first roller assembly having a first shaft and a second roller assembly having a second shaft; and
the second shaft has a second interface performance material that is different from the second interface performance material for the first shaft.
